(19) United States
(12) Patent Application Publication
(10) Pub. No.: US 2012/0002063 A1
(43) Pub. Date: Jan. 5, 2012

(54) CAMERA ADJUSTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/871,932

(22) Filed: Aug. 31, 2010

(30) Foreign Application Priority Data
Jun. 30, 2010 (TW) 99121552

(51) Int. Cl. H04N 5/232; H04N 5/222

(52) U.S. Cl. 348/211.2; 348/333.1; 348/231.99; 348/E05.022; 348/E05.042

(57) ABSTRACT

A camera adjusting system includes a camera, a control apparatus, and a monitor. The camera captures a first image of the eyes of a user. The control apparatus receives the first image, and determines the eye-motion of the user. Then the control apparatus adjusts the aim and/or focus of a PTZ camera according to the eye-motion of the user. The monitor displays a monitored area monitored by the PTZ camera.

### BACKGROUND

1. Technical Field

The present disclosure relates to a camera adjusting system and a camera adjusting method.

2. Description of Related Art

Pan-tilt-zoom (PTZ) cameras are commonly used in security systems and, generally, are remotely controlled through the use of computers. To adjust the aim and/or focus of the PTZ cameras, complex commands may be entered with a keyboard of the computer, which may be slow and inconvenient. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an exemplary embodiment of a camera adjusting system including a control apparatus, a camera, and a monitor.

FIG. 2 is a block diagram of an embodiment of the control apparatus of FIG. 1, the control apparatus includes a storing module.

FIG. 3 is a schematic view of images of eye-motions stored in the storing module of FIG. 2.

FIGS. 4a, 4b, 4c, 4d, and 4e are schematic views showing the camera adjusting system of FIG. 1 adjusting a Pan-tilt-zoom camera.

FIG. 5 is a flowchart of an embodiment of a camera adjusting method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

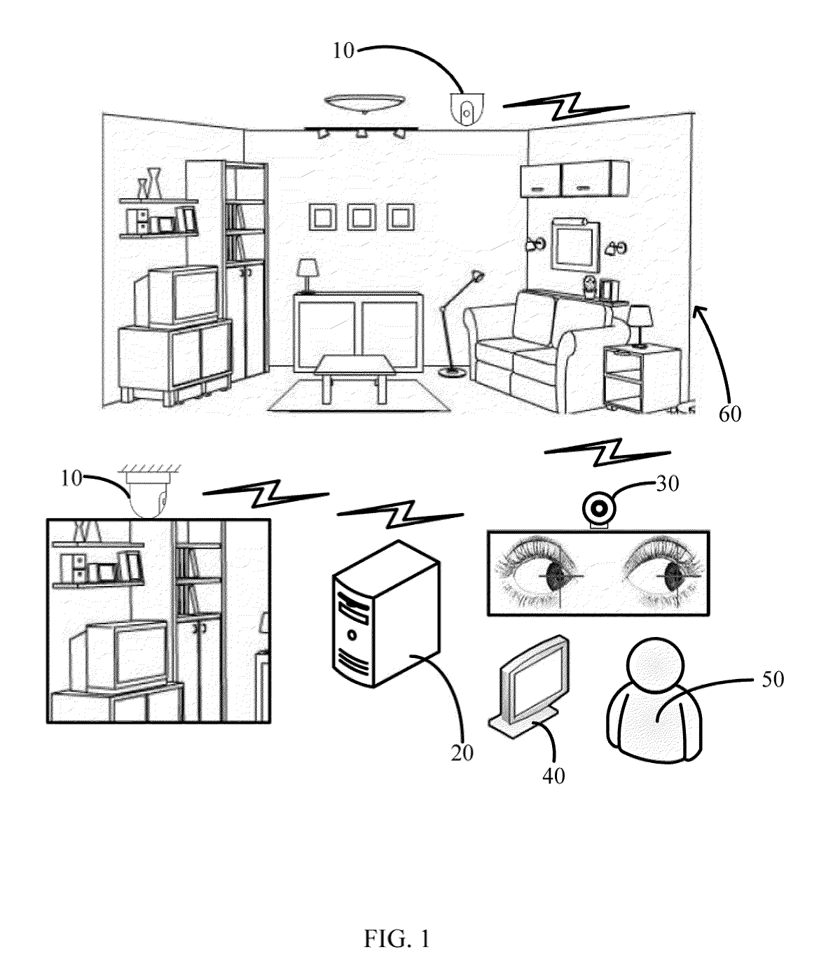

Referring to FIG. 1, an exemplary embodiment of a camera adjusting system used to adjust a Pan-tilt-zoom (PTZ) camera 10. The camera adjusting system 100 includes a control apparatus 20, a camera 30, and a monitor 40.

The PTZ camera 10 monitors a locale 60, such as a room. In one embodiment, the PTZ camera 10 is fixed on an appropriate position of a ceiling of the room 60. The monitor 40 is used to display the monitored area of the room 60 monitored by the PTZ camera 10. The control apparatus 20 communicates with the PTZ camera 10 and the camera 30 through a wired network or a wireless network.

The camera 30 is used to capture a first image of the eyes of a user 50, and send the first image to the control apparatus 20. The control apparatus 20 receives the first image, and determines the motion of the eyes (eye-motion) of the user 50, then adjusts the aim of the PTZ camera 10, according to the eye-motion of the user 50.

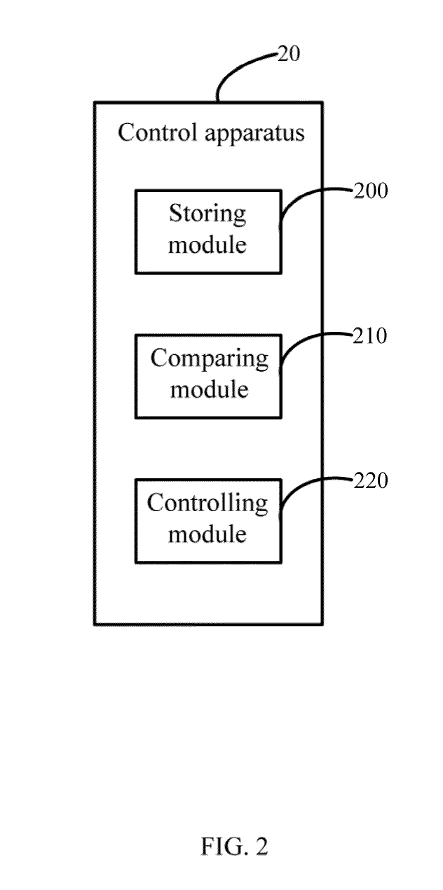

Referring to FIG. 2, the control apparatus 20 includes a storing module 200, a comparing module 210, and a control module 220.

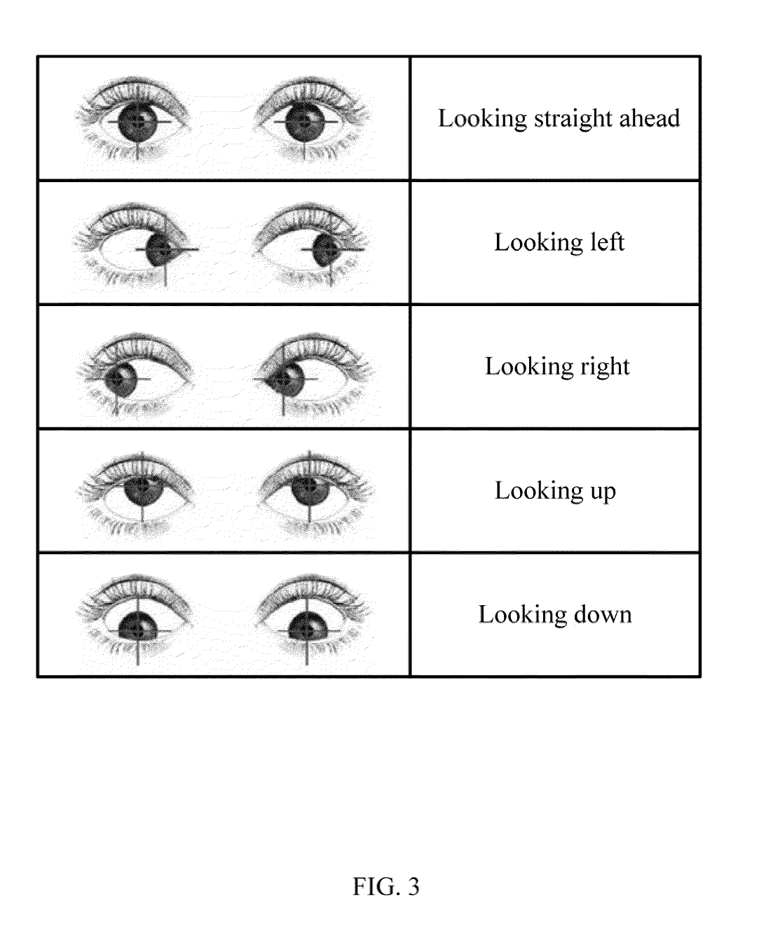

Referring to FIG. 3, the storing module 200 stores a number of second images of the eye-motion of the user 50. The eye-motion may be looking straight ahead, looking left, looking right, or looking up or down.

The comparing module 210 of the control apparatus 20 compares the first image captured by the camera 30 with the second images stored in the storing module 200, and then determines the eye-motion of the user 50. For example, when the eye-motion of the user 50 is looking left, the camera 30 captures a first image and the comparing module 210 compares the first image with all of the second images stored in the storing module 200. The comparing module 210 determines that the eye-motion of the user 50 is looking left if the first image is consistent to the second image of the eyes looking left.

The control module 220 of the control apparatus 20 adjusts the aim of the PTZ camera 10 according to the eye-motion of the user 50. For example, when the eye-motion of the user 50 is looking left, the control module 220 controls the lens of the PTZ camera 10 to turn left.

Five examples explaining the work process of the camera adjusting system 100 are given below.

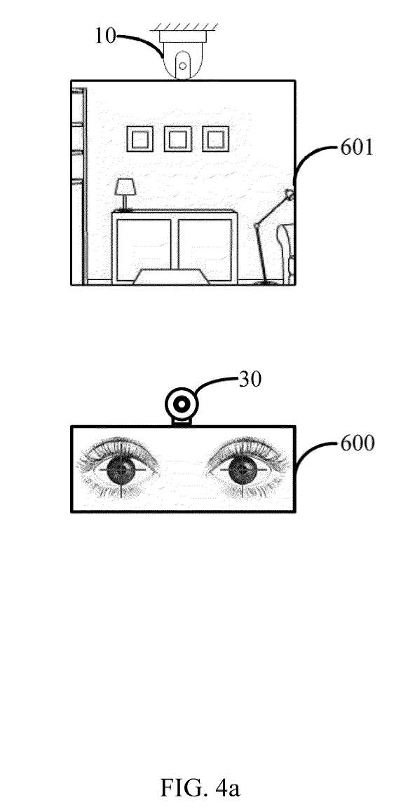

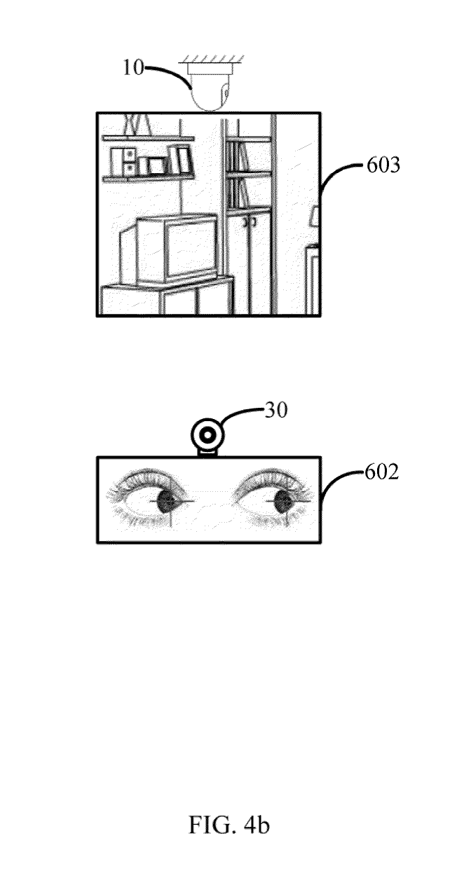

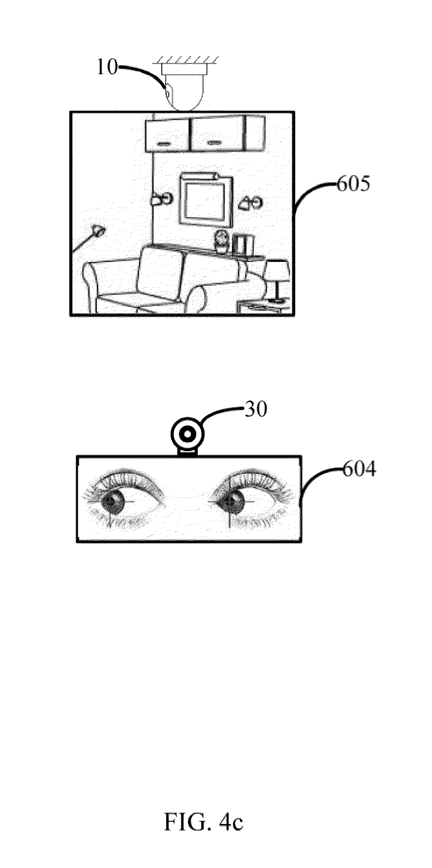

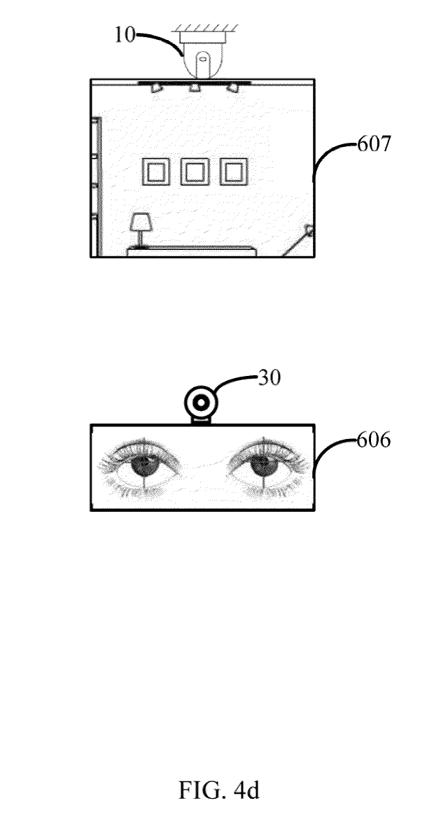

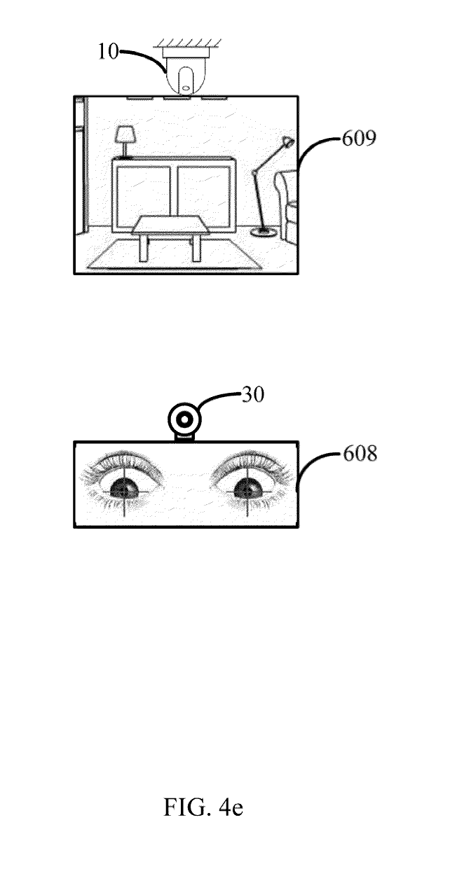

Referring to FIG. 4a, when the eye-motion of the user 50 is looking straight ahead, the camera 30 captures a first image 600 of the user 50 and the comparing module 210 compares the first image 600 with all of the second images stored in the storing module 200. The comparing module 210 determines that the eye-motion of the user 50 is looking straight ahead when the first image 600 is consistent to a second image of the eyes looking straight ahead. The control module 220 controls the lens of the PTZ camera 10 to remain inactive. After that, the monitor 40 displays a corresponding image 601 of a first area of the room 60.

Referring to FIG. 4b, when the eye-motion of the user 50 is looking left, the camera 30 captures a first image 602 of the user 50 and the comparing module 210 compares the first image 602 with all of the second images stored in the storing module 200. The comparing module 210 determines that the eye-motion of the user 50 is looking left when the first image 602 is consistent to the second image of the eyes looking left. The control module 220 controls the lens of the PTZ camera 10 to turn left. After that, the monitor 40 displays a corresponding image 603 of a second area of the room 60 which is to the left of the first area.

Referring to FIG. 4c, when the eye-motion of the user 50 is looking right, the camera 30 captures a first image 604 of the user 50 and the comparing module 210 compares the first image 604 with all of the second images stored in the storing module 200. The comparing module 210 determines that the eye-motion of the user 50 is looking right when the first image 604 is consistent with a second image of looking right. The control module 220 controls the lens of the PTZ camera 10 to turn right. After that, the monitor 40 displays a corresponding image 605 of a third area of the room 60, which is to the right of the first area.

Referring to FIG. 4d, when the eye-motion of the user 50 is looking up, the camera 30 captures a first image 606 of the user 50 and the comparing module 210 compares the first image 606 with all of the second images stored in the storing module 200. The comparing module 210 determines that the eye-motion of the user 50 is looking up when the first image 606 is consistent to a second image of the eyes looking up. The control module 220 controls the lens of the PTZ camera 10 to rise. After that, the monitor 40 displays a corresponding image 607 of a fourth area of the room 60, which is above the first area.

Referring to FIG. 4e, when the eye-motion of the user 50 is looking down, the camera 30 captures a first image 608 of the user 50 and the comparing module 210 compares the first image 608 with all of the second images stored in the storing module 200. The comparing module 210 determines that the eye-motion of the user 50 is looking down when the first image 608 is consistent to a second image of eyes looking down. The control module 220 controls the lens of the PTZ camera 10 to lower. After that, the monitor 40 displays a corresponding image 609 of a fifth area of the room 60, which is below the first area.

In another embodiment, the control module 220 further may change focus of the PTZ camera 10 according the eye-motion of the user 50.

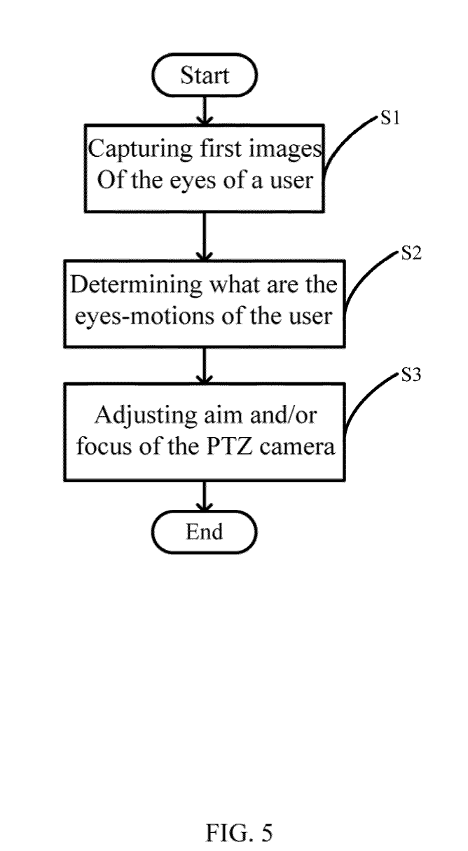

Referring to FIG. 5, an embodiment of a camera adjusting method includes the following steps.

In step 1, the camera 30 captures the first image of eyes of the user 50.

In step 2, the comparing module 210 determines the eye-motion of the user 50 by comparing the first image with the second images stored in the storing module 200.

In step 3, the control module 220 adjusts aim and/or focus of the PTZ camera 10.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera adjusting system for adjusting aim and/or focus of a Pan-tilt-zoom (PTZ) camera, the camera adjusting system comprising:
a camera capturing a first image of the eyes of a user;
a control apparatus receiving the first image, and determining the eye-motion of the user, then adjusting aim and/or focus of the PTZ camera, according to the eye-motion; and
a monitor displaying a monitored area monitored by the PTZ camera.

2. The camera adjusting system of claim 1, wherein the control apparatus comprises a storing module, a comparing module, and a control module, the storing module stores a plurality of second images of eye-motion, the comparing module compares the first image with the second images stored in the storing module, then the comparing module determines the eye-motion of the user, the control module adjusts aim and/or focus of the PTZ camera according to the eye-motion.

3. The camera adjusting system of claim 1, wherein the control apparatus communicates with the PTZ camera and the camera through a wireless network or a wired network.

4. A camera adjusting method for adjusting aim and/or focus of a Pan-tilt-zoom (PTZ) camera, the method comprising:
capturing a first image of the eyes of a user;
determining the eye-motion of the user;
adjusting aim and/or focus of the PTZ camera according to the eye-motion.

5. The method of claim 4, wherein a comparing module determines the eye-motion of the user by comparing the first image with second images stored in a storing module.
